(19) United States
(12) Patent Application Publication
(10) Pub. No.: US 2008/0132617 A1
(43) Pub. Date: Jun. 5, 2008

(54) Impact-resistance-modified filled polycarbonate compositions

(75) Inventors: Thomas Eckel, Dormagen (DE); Achim Feldermann, Dusseldorf (DE); Andreas Seidel, Dormagen (DE); Vera Buchholz, Koln (DE); Bernd Keller, Geldern (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/985,753

(22) Filed: Nov. 16, 2007

(30) Foreign Application Priority Data
Nov. 24, 2006 (GB) 102006055478.7

(51) Int. Cl. C08K 3/40

(52) U.S. Cl. 524/127; 524/1; 524/559; 524/576; 524/492; 524/494

(57) ABSTRACT

A thermoplastic molding composition comprising aromatic polycarbonate and/or aromatic polyester carbonate, a rubber-modified graft polymer and a plurality of hollow glass beads is disclosed.

The composition is distinguished by its improved flowability, high stiffness and small processing shrinkage, as well as unchanged high scratch resistance. The composition is suitable for producing molded articles having desirable properties.

### FIELD OF THE INVENTION

The present invention relates to thermoplastic molding compositions and in particular to filled polycarbonate compositions.

### TECHNICAL BACKGROUND OF THE INVENTION

In JP-A 11-199768 polycarbonate/ABS blends are described that have been made flame-resistant with monomeric and oligomeric phosphoric esters, the flame resistance being distinctly improved through addition of an inorganic filler such as talc, for example. However, the inorganic filler generally has an adverse effect on the mechanical properties, particularly on the toughness of the polymer blend.

JP-A 05-070653 describes hollow glass beads with high compressive strength by way of additive in maleimide-modified ABS molding compositions. The molding compositions have a reduced density, a high flexural modulus and good thermostability. No account is given of a favorable flow behavior, a diminished shrinkage or an enhanced scratch resistance.

In EP-A 198 648 thermoplastic molding compositions are disclosed that contain a spherical hollow filler with a particle size less than 500 μm. The filler has a ratio of external diameter to wall thickness of 2.5-10 and results in an increase in the stiffness and strength at low weight. The scratch resistance or flowability of such molding compositions is not described.

EP-A 391 413 describes the use of talc as filler in impact-resistance-modified polycarbonate. No influence on the scratch resistance or on the shrinkage due to processing is described.

Highly scratch-resistant molding compositions are known. For example, molding compositions consisting of a thermoplastic polycarbonate and solid glass beads are disclosed in DE-A 2 721 887. Films made of this material have a good light transmission and scratch resistance. No account is given of the flowability, stiffness or shrinkage due to processing of these molding compositions. But these molding compositions have the drawback that the solid glass beads increase the density of the thermoplastic molding compositions.

The object of the present invention is the provision of a molding composition that is distinguished by improved flowability, a high stiffness and a small processing shrinkage, with unchanged high scratch resistance. The molding composition may also be made flame-resistant.

### SUMMARY OF THE INVENTION

A thermoplastic molding composition comprising aromatic polycarbonate and/or aromatic polyester carbonate, a rubber-modified graft polymer and a plurality of hollow glass beads is disclosed. The composition is distinguished by its improved flowability, high stiffness, small processing shrinkage, as well as unchanged high scratch resistance. The composition is suitable for producing molded articles having desirable properties.

### DETAILED DESCRIPTION OF THE INVENTION

Surprisingly, it has been found that compositions containing
A) 10-90 parts by weight, preferably 50-85 parts by weight, of aromatic polycarbonate and/or aromatic polyester carbonate,
B) 0.5-30 parts by weight, preferably 1-25 parts by weight, particularly preferably 2-20 parts by weight, of rubber-modified graft polymer,
C) 0.1-50 parts by weight, preferably 0.5-20 parts by weight, particularly preferably 4-8 parts by weight, of hollow glass beads, and optionally
D) preferably 0-20 parts by weight, more preferably 1-18 parts by weight, particularly preferably 2-16 parts by weight, of phosphorus-containing flameproofing agent, and optionally
E) preferably 0-40 parts by weight, more preferably 1-30 parts by weight, of vinyl (co)polymer (E.1) and/or polyalkylene terephthalate (E.2), and optionally
F) preferably 0-10 parts by weight, more preferably 0.5-5 parts by weight, of conventional functional additives,

The sum of the parts by weight of all the components in the composition totaling 100, exhibit the desired property profile.

### Component A

Aromatic polycarbonates and/or aromatic polyester carbonates suitable in accordance with the invention according to component A are known from the literature or capable of being produced by processes known from the literature (on the production of aromatic polycarbonates, see, for example, Schnell, “Chemistry and Physics of Polycarbonates”, Interscience Publishers, 1964 and also DE-AS 1 495 626, DE-A 2 232 877, DE-A 2 703 376, DE-A 2 714 544, DE-A 3 000 610, DE-A 3 832 396; on the production of aromatic polyester carbonates, see, for example, DE-A 3 007 934).

The production of aromatic polycarbonates is undertaken, for example, by conversion of aromatic dihydroxy compounds (herein referred to as diphenols) with carbonic acid halides, preferably phosgene, and/or with aromatic dicarboxylic acid dihalides, preferably benzenedicarboxylic acid dihalides, in accordance with the phase-boundary process, optionally using chain terminators, for example monophenols, and optionally using trifunctional or more than trifunctional branching agents, for example triphenols or tetraphenols. Similarly, production is possible via a melt-polymerization process by conversion of diphenols with diphenyl carbonate, for example.

Diphenols for producing the aromatic polycarbonates and/or aromatic polyester carbonates are preferably those of the formula (I)

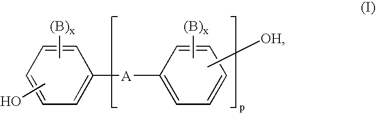

wherein
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, optionally including further aromatic rings, and optionally containing heteroatoms, or a residue of the formula (II) or (III)

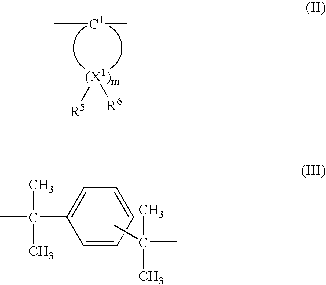

B is, in each instance, C₁ to C₁₂ alkyl, preferably methyl, or halogen, preferably chlorine and/or bromine,
x are, in each instance, independently of one another, 0, 1 or 2,
p is 1 or 0, and
R⁵ and R⁶ are individually selected for each X¹ and are, independently of one another, hydrogen or C₁ to C₆ alkyl, preferably hydrogen, methyl or ethyl,
X¹ is carbon and
m signifies an integer of 4 to 7, preferably 4 or 5, with the proviso that, on at least one atom X¹, R⁵ and R⁶ are simultaneously alkyl.

Preferred diphenols are hydroquinone, resorcinol, dihydroxydiphenols, bis(hydroxyphenyl)-C₁-C₃-alkanes, bis(hydroxyphenyl)-C₅-C₆-cycloalkanes, bis(hydroxyphenyl)ethers, bis(hydroxyphenyl)sulfoxides, bis(hydroxyphenyl)ketones, bis(hydroxyphenyl)sulfones and α,α-bis(hydroxyphenyl)diisopropylbenzenes and also the ring-brominated and/or ring-chlorinated derivatives thereof.

Particularly preferred diphenols are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenylsulfide, 4,4′-dihydroxydiphenylsulfone and also the dibrominated and tetrabrominated or chlorinated derivatives thereof, such as, for example, 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. Particularly preferred is 2,2-bis(4-hydroxyphenyl)propane (bisphenol A). The diphenols may be employed individually or in the form of arbitrary mixtures. The diphenols are known from the literature or may be obtained by known processes.

Suitable chain terminators for the production of the thermoplastic aromatic polycarbonates are, for example, phenol, p-chlorophenol, p-tert.-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols with a total of 8 to 20 C atoms in the alkyl substituents, such as 3,5-di-tert.-butylphenol, p-iso-octylphenol, p-tert.-octylphenol, p-dodecylphenol and 2-(3,5-dimethylheptyl)phenol and 4-(3,5-dimethylheptyl)phenol. The quantity of chain terminators to be employed amounts generally to between 0.5 mol % and 10 mol %, relative to the molar sum of the diphenols employed in the given case.

The thermoplastic aromatic polycarbonates have weight-average molecular weights (M_{w}, measured, for example, by GPC, ultracentrifuge or scattered-light measurement) of 10,000 to 200,000 g/mol, preferably 15,000 to 80,000 g/mol, particularly preferably 24,000 to 32,000 g/mol.

The thermoplastic aromatic polycarbonates may be branched in known manner, preferably through the incorporation of 0.05 mol % to 2.0 mol %, relative to the sum of the diphenols employed, of compounds having functionalities of three or more, for example those with three and more phenolic groups.

Suitable are both homopolycarbonates and copolycarbonates. For the purpose of producing copolycarbonates according to the invention according to component A, 1 wt. % to 25 wt. %, preferably 2.5 wt. % to 25 wt. %, relative to the total quantity of diphenols to be employed, polydiorganosiloxanes with hydroxyaryloxy terminal groups may also be employed. These are known (U.S. Pat. No. 3,419,634) and capable of being produced by processes known from the literature. Also suitable are copolycarbonates containing polydiorganosiloxane; the production of copolycarbonates containing polydiorganosiloxane is for example described in DE-A 3 334 782.

Preferred polycarbonates are, in addition to the bisphenol-A homopolycarbonates, the copolycarbonates of bisphenol A with up to 15 mol %, relative to the molar sums in respect of diphenols, of diphenols other than those named as being preferred or particularly preferred, in particular 2,2-bis(3,5-dibromo-4-hydroxyphenyl)propane.

Aromatic dicarboxylic acid dihalides for producing aromatic polyester carbonates are preferably the di-acid dichlorides of isophthalic acid, of terephthalic acid, of diphenyl ether 4,4′-dicarboxylic acid and of naphthalene-2,6-dicarboxylic acid. Particularly preferred are mixtures of the di-acid dichlorides of isophthalic acid and of terephthalic acid in a ratio between 1:20 and 20:1.

In the course of the production of polyester carbonates, in addition a carbonic acid halide, preferably phosgene, is used concomitantly as bifunctional acid derivative.

By way of chain terminator for the production of the aromatic polyester carbonates, besides the monophenols already mentioned, the chlorocarbonic esters thereof and the acid chlorides of aromatic monocarboxylic acids, optionally substituted by C₁ to C₂₂ alkyl groups or by halogen atoms and aliphatic C₂ to C₂₂ monocarboxylic acid chlorides are also suitable.

The quantity of chain terminators amounts in each instance to 0.1 mol % to 10 mol %, relative, in the case of the phenolic chain terminators, to moles of diphenol, and, in the case of monocarboxylic-acid-chloride chain terminators, to moles of dicarboxylic acid dichloride.

In the course of the production of aromatic polyester carbonates in addition one or more aromatic hydroxycarboxylic acid may be used.

The aromatic polyester carbonates may be both linear and branched in known manner (see DE-A 2 940 024 and DE-A 3 007 934).

By way of branching agent, use may be made, for example, of trifunctional or polyfunctional carboxylic acid chlorides, such as trimesic acid trichloride, cyanuric acid trichloride, 3,3′-4,4′-benzophenone tetracarboxylic acid tetrachloride, 1,4,5,8-naphthalenetetracarboxylic acid tetrachloride or pyromellitic acid tetrachloride, in quantities from 0.01 mol % to 1.0 mol % (relative to dicarboxylic acid dichlorides employed) or trifunctional or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxytriphenyl)propane, tetra(4-[4-ydroxyphenylisopropyl]phenoxy)methane, 1,4-bis[4,4′-dihydroxytriphenyl)methyl]benzene, in quantities from 0.01 mol % to 1.0 mol %, relative to diphenols employed. Phenolic branching agents may be charged together with the diphenols; acid-chloride branching agents may be charged together with the acid dichlorides.

In the thermoplastic aromatic polyester carbonates the proportion of carbonate structural units may vary arbitrarily. The proportion of carbonate groups preferably amounts to up to, yet excluding 100 mol %, in particular up to 80 mol %, particularly preferably up to 50 mol %, relative to the sum of ester groups and carbonate groups. Both the ester portion and the carbonate portion of the aromatic polyester carbonates may be present in the polycondensate in the form of blocks or in randomly distributed manner.

The relative solution viscosity (ηᵣₑₗ) of the aromatic polycarbonates and polyester carbonates lies within the range 1.18 to 1.4, preferably 1.20 to 1.32 (measured as solutions of 0.5 g polycarbonate or polyester carbonate in 100 ml methylene-chloride solution at 25° C.).

The thermoplastic aromatic polycarbonates and polyester carbonates may be employed on their own or in an arbitrary mixture.

### Component B

Component B comprises one or more graft polymers of
B.1 5 wt. % to 95 wt. %, preferably 30 wt. % to 90 wt. %, of at least one vinyl monomer on
B.2 95 wt. % to 5 wt. %, preferably 70 wt. % to 10 wt. %, of one or more graft bases with glass transition temperatures <10° C., preferably <0° C., particularly preferably <−20° C.

The graft base B.2 generally has a mean particle size (d₅₀ value) from 0.05 μm to 10 μm, preferably 0.1 μm to 5 μm, particularly preferably 0.2 μm to 1 μm.

Monomers B.1 are preferably mixtures consisting of
B.1.1 50 parts by weight to 99 parts by weight of vinyl aromatics and/or ring-substituted vinyl aromatics (such as styrene, α-methylstyrene, p-methylstyrene, p-chlorostyrene) and/or C₁-C₈ alkyl (meth)acrylates, such as methyl methacrylate, ethyl methacrylate, and
B.1.2 1 part by weight to 50 parts by weight of vinyl cyanides (unsaturated nitriles such as acrylonitrile and methacrylonitrile) and/or C₁-C₈ alkyl (meth)acrylates, such as methyl methacrylate, n-butyl acrylate, t-butyl acrylate, and/or derivatives (such as anhydrides and imides) of unsaturated carboxylic acids, for example maleic anhydride and N-phenyl maleimide.

Preferred monomers B.1.1 are at least one member selected from the group consisting of styrene, α-methylstyrene and methyl methacrylate; preferred monomers B.1.2 are at least one member selected from the group consisting of acrylonitrile, maleic anhydride and methyl methacrylate. Particularly preferred monomers are B.1.1 styrene and B.1.2 acrylonitrile.

Suitable graft bases B.2 are, for example, diene rubbers, EP(D)M rubbers, i.e. those based on ethylene/propylene and optionally diene, acrylate rubbers, polyurethane rubbers, silicone rubbers, chloroprene and ethylene/vinyl-acetate rubbers.

Preferred graft bases B.2 are diene rubbers, for example based on butadiene and isoprene, or mixtures of diene rubbers or copolymers of diene rubbers or mixtures thereof with further copolymerizable monomers (e.g. according to B.1.1 and B.1.2), with the proviso that the glass transition temperature of component B.2 lies below <10° C., preferably <0° C., particularly preferably <−10° C. Pure polybutadiene rubber is particularly preferred.

Particularly preferred polymers B are, for example, ABS polymers (emulsion ABS, bulk ABS and suspension ABS), such as are described, for example, in DE-OS 2 035 390 (=U.S. Pat. No. 3,644,574) or in DE-OS 2 248 242 (=GB-PS 1 409 275) or in Ullmanns Enzyklopädie der Technischen Chemie, Vol. 19 (1980), p 280 ff. The gel proportion of graft base B.2 amounts to at least 30 wt. %, preferably at least 40 wt. % (measured in toluene).

The graft copolymers B are produced by radical polymerization, for example by emulsion polymerization, suspension polymerization, solution polymerization or bulk polymerization, preferably by emulsion polymerization or bulk polymerization.

Particularly preferred graft rubbers are also ABS polymers produced by emulsion-polymerization by redox initiation with an initiator system consisting of organic hydroperoxide and ascorbic acid in accordance with U.S. Pat. No. 4,937,285. Since in the course of the graft reaction the graft monomers are known to be not necessarily completely grafted onto the graft base, in accordance with the invention the expression ‘graft polymers B’ is also understood to mean products that include in addition to the graft polymer, ungrafted (co)polymers of B.1 that accrue concomitantly in the course of processing.

Suitable acrylate rubbers according to B.2 of the polymers B are preferably polymers consisting of alkyl acrylates, optionally with up to 40 wt. %, relative to B.2, of other polymerizable, ethylenically unsaturated monomers. The preferred polymerizable acrylic esters include C₁ to C₈ alkyl esters, for example methyl, ethyl, butyl, n-octyl and 2-ethylhexyl esters; halogen alkyl esters, preferably halogen C₁-C₈ alkyl esters, such as chloroethyl acrylate and also mixtures of these monomers.

For the purpose of crosslinking, monomers with more than one polymerizable double bond may be copolymerized. Preferred examples of crosslinking monomers are esters of unsaturated monocarboxylic acids with 3 to 8 C atoms and of unsaturated monohydric alcohols with 3 to 12 C atoms, or of saturated polyols with 2 to 4OH groups and 2 to 20 C atoms, such as ethylene glycol dimethacrylate, allyl methacrylate; polyunsaturated heterocyclic compounds, such as trivinyl cyanurate and triallyl cyanurate; polyfunctional vinyl compounds, such as divinylbenzenes and trivinylbenzenes; but also triallyl phosphate and diallyl phthalate. Preferred crosslinking monomers are allyl methacrylate, ethylene glycol dimethacrylate, diallyl phosphate and heterocyclic compounds that exhibit at least three ethylenically unsaturated groups. Particularly preferred crosslinking monomers are the cyclic monomers triallyl cyanurate, triallyl isocyanurate, triacryloylhexahydro-s-triazine, and triallylbenzenes. The quantity of the crosslinked monomers preferably amounts to 0.02 wt. % to 5 wt. %, in particular 0.05 wt. % to 2 wt. %, relative to the graft base B.2. In the case of cyclic crosslinking monomers with at least three ethylenically unsaturated groups, it is advantageous to restrict the quantity to below 1 wt. % of the graft base B.2.

Preferred “other” polymerizable, ethylenically unsaturated monomers that, in addition to the acrylic esters, may optionally serve for producing the graft base B.2 are, for example, acrylonitrile, styrene, α-methylstyrene, acrylamides, vinyl C₁-C₆ alkyl ethers, methyl methacrylate, butadiene. Preferred acrylate rubbers for graft base B.2 are emulsion polymers that exhibit a gel content of at least 60 wt. %.

Further suitable graft bases according to B.2 are silicone rubbers with graft-active sites, such as are described in DE-OS 3 704 657, DE-OS 3 704 655, DE-OS 3 651 540 and DE-OS 3 631 539.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The mean particle size d₅₀ is that diameter, above and below which in each instance 50 wt. % of the particles lie. It may be determined by means of ultracentrifuge measurement (W. Scholtan, H. Lange, Kolloid-Z. und Z. f. Polymere, 250 (1972), 782-796).

### Component C

Hollow glass beads according to the invention are preferably of borosilicate glass which is preferably low in alkali. Particularly preferred hollow glass beads are characterized in that the content of alkali-metal oxides (preferably sodium oxide) amounts to 1-10 wt. %, preferably 3-8 wt. %, the content of alkaline-earth-metal oxides (preferably calcium oxide) amounts to 5-20 wt. %, preferably 8-15 wt. %, and the content of boron oxides amounts to 1-10 wt. %, preferably 2-6 wt. %, the percents are relative to the weight of the glass.

The hollow glass beads preferably have densities of 0.2-0.8 g/cm³, preferably 0.4-0.7 g/cm³, particularly preferably 0.55-0.65 g/cm³, and mean particle diameter (d₅₀) of 1-200 μm, preferably 5-100 μm, particularly preferably 15-50 μm.

Preferred hollow glass beads are distinguished by a high compressive strength of 10-200 MPa, preferably 40-150 MPa. The compressive strength is the isostatic pressure under which at least 80% of the beads remain undamaged.

The hollow glass beads according to the invention may have been surface-treated—for example, silanized—in order to enhance their compatibility with the polymer.

### Component D

The phosphorus-containing flameproofing agent (D) according to the invention is preferably at least one member selected from the group comprising monomeric and oligomeric phosphoric and phosphonic esters, phosphonate amines and phosphazenes. Other halogen-free phosphorus compounds, not mentioned especially here, may also be employed on their own or in any combination with other halogen-free phosphorus compounds.

Preferred monomeric and oligomeric phosphoric and phosphonic esters are phosphorus compounds of the general formula (IV)

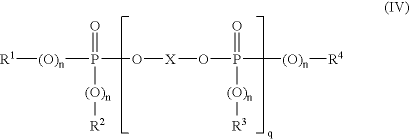

wherein
R¹, R², R³ and R⁴ signify in each instance, independently of one another, C₁ to C₈ alkyl, or C₅ to C₆ cycloalkyl, C₆ to C₂₀ aryl or C₇ to C₁₂ aralkyl, in each instance optionally substituted by alkyl, preferably C₁ to C₄ alkyl, and/or by halogen, preferably chlorine, bromine,
n signify, independently of one another, 0 or 1,
q signifies 0 to 30 and
X signifies a mononuclear or polynuclear aromatic residue with 6 to 30 C atoms, or a linear or branched aliphatic residue with 2 to 30 C atoms, which may be OH-substituted and may include up to 8 ether bonds.

R¹, R², R³ and R⁴ preferably stand, independently of one another, for C₁ to C₄ alkyl, phenyl, naphthyl or phenyl-C₁-C₄-alkyl. The aromatic groups R¹, R², R³ and R⁴ may, in turn, be substituted with halogen groups and/or alkyl groups, preferably chlorine, bromine and/or C₁ to C₄ alkyl. Particularly preferred aryl residues are cresyl, phenyl, xylenyl, propylphenyl or butylphenyl, as well as the corresponding brominated and chlorinated derivatives thereof.
X in formula (IV) preferably signifies a mononuclear or polynuclear aromatic residue with 6 to 30 C atoms. Said residue is preferably derived from diphenols of the formula (I).
n in formula (IV) may be, independently of one another, 0 or 1; n is preferably equal to 1.
q stands for values from 0 to 30, preferably 0.3 to 20, particularly preferably 0.5 to 10, in particular 0.5 to 6, quite particularly preferably 1.1 to 1.6.
X stands in particularly preferred manner for

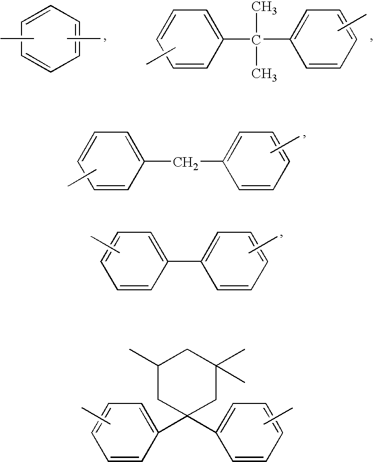

or the chlorinated or brominated derivatives thereof; in particular, X is derived from resorcinol, hydroquinone, bisphenol A or diphenylphenol. In particularly preferred manner X is derived from bisphenol A.

Mixtures of various phosphates may also be employed.

Phosphorus compounds of the formula (IV) are, in particular, tributyl phosphate, triphenyl phosphate, tricresyl phosphate, diphenylcresyl phosphate, diphenyloctyl phosphate, diphenyl-2-ethylcresyl phosphate, tri(isopropylphenyl) phosphate, resorcinol-bridged oligophosphate and bisphenol-A-bridged oligophosphate. The use of oligomeric phosphoric esters of the formula (IV) that are derived from bisphenol A is particularly preferred.

Most preferred as component D is Bisphenol-A-based oligophosphate according to formula (IVa).

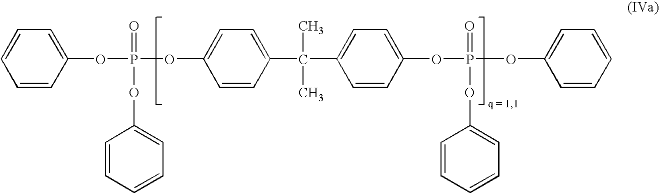

The phosphorus compounds are known (cf., for example, EP-A 0 363 608, EP-A 0 640 655) or may be produced in analogous manner by known methods (e.g. Ullmanns Enzyklopädie der technischen Chemie, Vol. 18, p 301 ff. 1979; Houben-Weyl, Methoden der organischen Chemie, Vol. 12/1, p 43; Beilstein, Vol. 6, p 177).

In case of mixtures of various phosphorus compounds and in case of oligomeric phosphorus compounds are employed, the q-value means stands for “mean q-value”. The mean q-value may be determined by the composition of the phosphorous compound (molecular-weight distribution) being determined by means of suitable methods (gas chromatography (GC), high-pressure liquid chromatography (HPLC), gel permeation chromatography (GPC)), and by the mean values of q being calculated therefrom.

Furthermore, phosphonate amines and phosphazenes, such as are described in WO 00/00541 and WO 01/18105, may be employed as flameproofing agents. The flameproofing agents may be employed on their own or in any mixture with one another or in a mixture with other flameproofing agents.

### Component E

Component E comprises one or more thermoplastic vinyl (co)polymers E.1 and/or polyalkylene terephthalates E.2.

Suitable as vinyl (co)polymers E.1 are polymers of at least one monomer selected from among vinyl aromatics, vinyl cyanides (unsaturated nitriles), C₁-C₈ alkyl (meth)acrylates, unsaturated carboxylic acids and also derivatives (such as anhydrides and imides) of unsaturated carboxylic acids. Particularly suitable are (co)polymers formed from
E.1.1 50 parts by weight to 99 parts by weight, preferably 60 parts by weight to 80 parts by weight, of vinyl aromatics and/or ring-substituted vinyl aromatics such as styrene, α-methylstyrene, p-methylstyrene, p-chlorostyrene and/or C₁-C₈ alkyl (meth)acrylates such as methyl methacrylate, ethyl methacrylate, and
E.1.2 1 part by weight to 50 parts by weight, preferably 20 parts by weight to 40 parts by weight, of vinyl cyanides (unsaturated nitriles) such as acrylonitrile and methacrylonitrile and/or C₁-C₈ alkyl (meth)acrylates, such as methyl methacrylate, n-butyl acrylate, t-butyl acrylate, and/or unsaturated carboxylic acids, such as maleic acid, and/or derivatives, such as anhydrides and imides, of unsaturated carboxylic acids, for example maleic anhydride and N-phenyl maleimide.

The vinyl (co)polymers E.1 are resinous, thermoplastic and rubber-free. In particularly preferred manner the copolymer is formed from E.1.1 styrene and E.1.2 acrylonitrile.

The (co)polymers according to E.1 are known and may be produced by radical polymerization, in particular by emulsion polymerization, suspension polymerization, solution polymerization or bulk polymerization. The (co)polymers preferably have molecular weights M_{w} (weight average, ascertained by scattering of light or by sedimentation) between 15,000 and 200,000.

The polyethylene terephthalates of component E.2 are reaction products formed from aromatic dicarboxylic acids or their reactive derivatives, such as dimethyl esters or anhydrides, and aliphatic, cycloaliphatic or araliphatic diols, as well as mixtures of these reaction products.

Preferred polyalkylene terephthalates include at least 80 wt. %, preferably at least 90 wt. %, relative to the dicarboxylic-acid component, terephthalic-acid residues and at least 80 wt. %, preferably at least 90 mol %, relative to the diol component, ethylene-glycol residues and/or butanediol-1,4 residues.

The preferred polyalkylene terephthalates may include, in addition to terephthalic-acid residues, up to 20 mol %, preferably up to 10 mol %, residues of other aromatic or cycloaliphatic dicarboxylic acids with 8 to 14 C atoms, or of aliphatic dicarboxylic acids with 4 to 12 C atoms, such as, for example, residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may include, in addition to ethylene-glycol residues or butanediol-1,4 residues, up to 20 mol %, preferably up to 10 mol %, other aliphatic diols with 3 to 12 C atoms or cycloaliphatic diols with 6 to 21 C atoms, for example residues of propanediol-1,3,2-ethylpropanediol-1,3, neopentyl glycol, pentanediol-1,5, hexanediol-1,6, cyclohexanedimethanol-1,4,3-ethylpentanediol-2,4,2-methylpentanediol-2,4,2,2,4-trimethylpentanediol-1,3,2-ethylhexanediol-1,3,2,2-diethylpropanediol-1,3, hexanediol-2,5,1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A-2 715 932).

The polyalkylene terephthalates may be branched by incorporation of relatively small quantities of trihydric or tetrahydric alcohols or of tribasic or tetrabasic carboxylic acids, for example according to DE-A 1900 270 and U.S. Pat. No. 3,692,744. Examples of preferred branching agents are trimesic acid, trimellitic acid, trimethylolethane, trimethylolpropane and pentaerythritol.

Particularly preferred are polyalkylene terephthalates that have been produced solely from terephthalic acid and the reactive derivatives thereof (e.g. the dialkyl esters thereof) and ethylene glycol and/or butanediol-1,4, and mixtures of these polyalkylene terephthalates.

Mixtures of polyalkylene terephthalates contain 1 wt. % to 50 wt. %, preferably 1 wt. % to 30 wt. %, polyalkylene terephthalate and 50 wt. % to 99 wt. %, preferably 70 wt. % to 99 wt. %, polybutylene terephthalate.

The polyalkylene terephthalates that are preferably used generally have an intrinsic viscosity from 0.4 dl/g to 1.5 dl/g, preferably 0.5 dl/g to 1.2 dl/g, measured in phenol/o-dichlorobenzene (1:1 parts by weight) at 25° C. in an Ubbelohde viscometer.

The polyalkylene terephthalates may be produced by known methods (see, for example, Kunststoff-Handbuch, Volume VIII, p 695 ff., Carl-Hanser-Verlag, Munich 1973).

### Further Added Substances F

The composition may contain further conventional functional polymer additives (component F) such as flame-retardant synergists, anti-dripping agents (for example, compounds of the substance classes comprising the fluorinated polyolefins, the silicones and also aramide fibres), lubricants and mold-release agents (for example, pentaerythritol tetrastearate), nucleating agents, stabilizers, antistatic agents (for example, conductive carbon blacks, carbon fibers, metal fibers, carbon nanotubes and also organic antistatic agents such as polyalkylene ethers, alkyl sulfonates or polyamide-containing polymers) and also dyestuffs and pigments.

### Production of the Molding Compositions and Molded Articles

The thermoplastic molding compositions according to the invention are produced by the respective constituents being mixed in known manner and by being melt-compounded and melt-extruded at temperature of 200° C. to 300° C. in conventional units such as internal kneaders, extruders and double-shafted screws.

The mixing of the individual constituents may be undertaken in known manner both successively and simultaneously, specifically both at approximately 20° C. (room temperature) and at higher temperature.

The invention also provides processes for producing the molding compositions, and the use of the molding compositions for the purpose of producing molded articles.

The molding compositions according to the invention can be used for the purpose of producing molded articles of any type. These may be produced by injection molding, extrusion and blow-molding processes. A further form of processing is the production of molded articles by thermoforming from previously produced sheets or films.

Examples of such molded articles are films, profiled sections, housing parts of any type, for example for household appliances such as juicers, coffee machines, mixers; for office machines such as monitors, flatscreens, notebooks, printers, copiers; panels, pipes, electrical-installation conduits, windows, doors and other profiled sections for the construction industry (interior finishing and external applications) and also electrical and electronic components such as switches, plugs and sockets and also bodywork components or interior components for utility vehicles, in particular for the automobile field.

In particular, the molding compositions according to the invention may, for example, also be used for the purpose of producing the following molded articles or moldings: interior-finishing components for rail vehicles, ships, aircraft, buses and other motor vehicles, housings of electrical appliances containing small transformers, housings for devices for the processing and communication of information, housings and jacketing of medical instruments, massage equipment and housings for such equipment, toy vehicles for children, planar wall elements, housings for safety devices, thermally insulated shipping containers, moldings for sanitary equipment and bath equipment, covering gratings for ventilator openings and housings for gardening implements.

The following Examples serve for further elucidation of the invention.

### EXAMPLES

### Component A1

Linear polycarbonate based on bisphenol A with a weight-averaged molecular weight M_{w} of 27,500 g/mol (determined by GPC).

### Component A2

Linear polycarbonate based on bisphenol A with a weight-averaged molecular weight M_{w} of 25,000 g/mol (determined by GPC).

### Component B1

ABS polymer, produced by emulsion polymerization of 43 wt. % (relative to the ABS polymer) of a mixture consisting of 27 wt. % acrylonitrile and 73 wt. % styrene in the presence of 57 wt. % (relative to the ABS polymer) of a polybutadiene rubber crosslinked in particulate manner (mean particle diameter d₅₀=0.35 μm).

### Component C1

The hollow glass beads are made of low-alkali borosilicate glass, i.e. of 5.5 wt. % Na₂O, 11.5 wt. % CaO and 4 wt. % B₂O₃. The hollow glass beads exhibit a density of 0.6 g/cm³ and a mean diameter of 30 μm. The hollow glass beads have an isostatic compressive strength of 124 MPa.

### Component C2

The solid glass beads (Vitrolite 20 manufactured by VitroCo Enterprises, Irvine, Calif., USA) consist of amorphous silicates and alumosilicates of sodium, potassium, calcium, magnesium and iron and have a mean diameter of 12 μm and density of 2.4 g/cm³.

### Component C3

Talc, Luzenac® A3C manufactured by Luzenac Naintsch Mineralwerke GmbH having MgO content of 32 wt. %, SiO₂ content of 61 wt. % and Al₂O₃ content of 0.3 wt. %.

### Component D

Bisphenol-A-based oligophosphate (Reofoss BAPP)

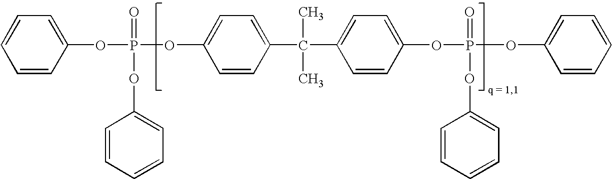

### Component E1

Copolymer formed from 77 wt. % styrene and 23 wt. % acrylonitrile with a weight-averaged molecular weight M_{w} of 130 kg/mol (determined by GPC), produced in accordance with the bulk process.

### Component E2

Copolymer formed from 72 wt. % styrene and 28 wt. % acrylonitrile with a weight-averaged molecular weight M_{w} of 140 kg/mol (determined by GPC), produced in accordance with the bulk process.

### Component F

F1: polytetrafluoroethylene powder, CFP 6000 N, Du Pont

F2: pentaerythritol tetrastearate by way of lubricant/mold-release agent

F3: phosphite stabilizer, Irganoxe® 900, Ciba Speciality Chemicals

### Production and Testing of the Molding Compositions

In a twin-screw extruder (ZSK-25) (Werner und Pfleiderer) the feed materials listed in Table 1 were compounded and granulated at a rotary speed of 225 rpm and with a throughput of 20 kg/h at a machine temperature of 260° C. The finished granulates were processed in an injection-molding machine to yield the corresponding test specimens (melt temperature 240° C., Examples 3-5, and 260° C., Examples 1-2, tool temperature 80° C., flow-front velocity 240 mm/s).

For the purpose of characterising the properties of the test specimens, the following methods were applied:

The shrinkage due to processing was measured following the model of ISO standard 294-4, though in respect of shrinkage sheets with dimensions 150 mm×105 mm×3 mm.

The flowability was determined in accordance with DIN EN ISO 1133 as melt volume-flow rate (MVR) and on the basis of ISO 11443 as melt viscosity. Tearing strength was measured in accordance with DIN EN ISO 527.

The stiffness was measured as tensile modulus of elasticity in accordance with DIN EN ISO 527.

The scratch resistance was determined as pencil hardness in accordance with ASTM D-3363. In this connection, pencils of hardness 3H, 2H, H, F, HB, B, 2B and 3B (here, decreasing hardness) are conducted over the surface with defined pressure. The pencil hardness specifies the hardest pencil with which no scratch is discernible.

TABLE 1
Composition and properties of the molding compositions

| Composition | | |
|---|---|---|
| [wt. %] | 1 | 2 (ref.) |
| A1 | 56.3 | 56.3 |
| B1 | 16.2 | 16.2 |
| C1 | 4.8 | — |
| C2 | — | 4.8 |
| E1 | 5.7 | 5.7 |
| E2 | 16.2 | 16.2 |
| F2 | 0.7 | 0.7 |
| F3 | 0.1 | 0.1 |
| Shrinkage due to processing | | |
| Lengthwise [%] | 0.740 | 0.764 |
| MVR (260° C./5 kg) [cm³/10 min] | 16.7 | 12.6 |
| Tensile modulus of elasticity | 2387 | 2261 |
| [N/mm] | | |
| Scratch resistance | | |
| acc. to ASTM D-3363 | F | F |

It is evident from Table 1 that the composition according to the invention according to Example 1 exhibits a smaller shrinkage due to processing, an improved flowability and higher stiffness in comparison with the composition of Reference Example 2.

TABLE 2
Composition and properties of the
flameproofed molding compositions

| Composition | | | |
|---|---|---|---|
| [wt. %] | 3 | 4 (ref.) | 5 (ref.) |
| A2 | 61.2 | 61.2 | 61.2 |
| B1 | 8.6 | 8.6 | 8.6 |
| C1 | 4.8 | — | — |
| C2 | — | 4.8 | — |
| C3 | — | — | 4.8 |
| D | 14.4 | 14.4 | 14.4 |
| E1 | 10.0 | 10.0 | 10.0 |
| F1 | 0.5 | 0.5 | 0.5 |
| F2 | 0.4 | 0.4 | 0.4 |
| F3 | 0.1 | 0.1 | 0.1 |
| Shrinkage due to processing | | | |
| Lengthwise [%] | 0.525 | 0.553 | n.m. |
| Melt viscosity [Pas] | | | |
| 1000 s⁻¹/240° C. | 201 | 217 | 209 |
| 1000 s⁻¹/260° C. | 133 | 151 | 144 |
| 1000 s⁻¹/280° C. | 78 | 97 | 92 |
| MVR (240° C./5 kg) [cm³/10 min] | 23.9 | 20.0 | 21.3 |
| Tensile modulus of elasticity | 2950 | 2920 | 3300 |
| [N/mm] | | | |
| Tearing strength [N/mm] | 49 | 44 | 45 |
| Scratch resistance | | | |
| acc. to ASTM D-3363 | H | H | F |

n.m. = not measured

In the case of the flameproofed compositions of Table 2, only the composition according to the invention according to Example 3 accomplishes the task according to the invention, i.e. with comparable scratch resistance (in comparison with Reference Example 4) a smaller shrinkage due to processing, an improved flowability and also a higher stiffness are achieved. Reference Example 5 with talc as filler does not satisfy the criterion of high scratch resistance.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
A) 10-90 parts by weight of at least one member selected from the group consisting of aromatic polycarbonate and aromatic polyester carbonate,
B) 0.5-30 parts by weight of rubber-modified graft polymer and
C) 0.1-50 parts by weight of a plurality of hollow glass beads.

2. The composition of claim 1 further containing a phosphorous-containing flame proofing agent.

3. The composition of claim 1 further containing at least one member selected from the group consisting of vinyl (co)polymer and polyalkylene terephthalate.

4. The composition according to claim 1, wherein the hollow glass beads comprise borosilicate glass.

5. The composition according to claim 1 wherein the hollow glass beads exhibit a density of 0.2-0.8 g/cm³.

6. The composition according to claim 1 wherein the glass beads exhibit mean particle size (d₅₀) of 1 μm to 200 μm.

7. The composition according to claim 1 wherein the hollow glass beads have compressive strengths of 10-200 MPa.

8. The composition according to claim 2 wherein the phosphorus-containing flameproofing agent conforms to formula (IV) 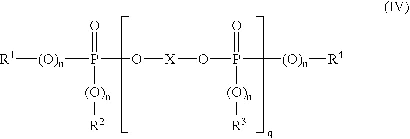
wherein
R¹, R², R¹ and R⁴ signify in each instance, independently of one another, C₁ to C₈ alkyl, C₅ to C₆ cycloalkyl, C₆ to C₂₀ aryl or C₇ to C₁₂ aralkyl, in each instance optionally substituted by alkyl, and/or halogen,
n signify, independently of one another, 0 or 1,
q signifies 0 to 30 and
X signifies a mononuclear or polynuclear aromatic residue with 6 to 30 C atoms, or a linear or branched aliphatic residue with 2 to 30 C atoms, optionally OH-substituted and optionally including up to 8 ether bonds.

9. The composition according to claim 6, wherein X in denotes the residue of bisphenol A.

10. The composition according to claim 1 further containing at least one member selected from the group consisting of flame-retardant synergist, anti-dripping agent, lubricant, mold-release agent, nucleating agent, stabilizer, antistatic agent, dyestuff and pigment.

11. A molded article containing the composition of claim 1.
